(19) United States
(12) Patent Application Publication
(10) Pub. No.: US 2018/0207783 A1
(43) Pub. Date: Jul. 26, 2018

(54) Portable Power Tool

(71) Applicant: Hilti Aktiengesellschaft, Schaan (LI)

(72) Inventors: Bernhard LIEBERT, Pfaffenhofen a. d. Glonn (DE); Olaf KOCH, Kaufering (DE); Jerome JAROMIN, Muenchen (DE)

(73) Assignee: Hilti Aktiengesellschaft, Schaan (LI)

(21) Appl. No.: 15/745,415

(22) PCT Filed: Jul. 12, 2016
(86) PCT No.: PCT/EP2016/066501

§ 371 Date: Jan. 16, 2018

(30) Foreign Application Priority Data
Jul. 17, 2015 (EP) 15177226.6

(51) Int. Cl. B25D 17/06; B25D 16/00; B25D 11/12; B25D 11/06

(52) U.S. Cl. CPC B25D 17/06; B25D 16/00; B25D 11/125; B25D 2211/068; B25D 2217/0023; B25D 2250/051; B25D 2250/065; B25D 11/062

(57) ABSTRACT

A portable power tool has an exciter piston guided along a movement axis in a guide tube and a striker coupled to the exciter piston. A connecting rod is fastened to a piston pin in the exciter piston and to an electric motor. A bearing for supporting the piston pin is formed by a piston head of the exciter piston and a closure plate inserted into the exciter piston. A rotary closure is formed by a groove, extending in a direction of rotation about the movement axis, in the piston wall and by a radially protruding fin on the closure plate. A detent for locking the fin counter to the direction of rotation is pivotable in the radial direction between a locking position and a releasing position. The detent is deflected beyond the external dimensions of the piston wall in the radial direction in the releasing position.

This application claims the priority of International Application No. PCT/EP2016/066501, filed Jul. 12, 2016, and European Patent Document No. 15177226.6, filed Jul. 17, 2015, the disclosures of which are expressly incorporated by reference herein.

### BACKGROUND AND SUMMARY OF THE INVENTION

This invention relates to a portable power tool for chiseling or boring.

A hammer drill is known from EP 2 857 149. The hammer drill has a pneumatic percussion mechanism with an exciter piston that is guided in a guide tube. A closure plate clamps a connecting rod in the exciter piston.

A portable power tool according to the invention has a tool holder to hold a tool, an electric motor and a percussion mechanism. The percussion mechanism has an exciter piston that is guided in a guide tube along a motion axis and a striker coupled to the exciter piston via a pneumatic chamber, wherein a piston wall of the exciter piston comes into contact with the guide tube. A connecting rod is fastened on one end to a piston pin in the exciter piston and with its other end is coupled with the electric motor. A bearing that supports the piston pin is formed by a piston head of the exciter piston and a closure plate inserted into the exciter piston and located opposite the piston head. A rotary closure is formed by a groove that runs in a direction of rotation around the movement axis in the piston wall of the exciter piston and by a radially protruding fin on the closure plate. A detent for locking the fin counter to the direction of rotation can be pivoted in the radial direction between a locking position and a releasing position, wherein the detent is deflected beyond the external dimensions of the piston wall in the radial direction in the releasing position.

The closure plate can be inserted into the hollow exciter piston and fastened by means of the rotary closure. The detent prevents the unwanted free rotation of the closure plate. The detent itself is checked by the guide tube that must be able to project beyond the piston wall for the releasing position.

The following description explains the invention on the basis of exemplary embodiments and the accompanying figures.

### BRIEF DESCRIPTION OF THE DRAWINGS

FIG. 1 shows a hammer drill;

FIG. 2 shows an exciter piston with connecting rod in a longitudinal section;

FIG. 3 is a perspective view of the exciter piston;

FIG. 4 is a view of the exciter piston from the back side;

FIG. 5 is a plan view of the front side of a closure plate;

FIG. 6 is a cross section in the plane VI-VI through the exciter piston and the unlocked closure plate; and

FIG. 7 is a cross section in the plane VI-VI through the exciter piston and the locked closure plate.

### DETAILED DESCRIPTION OF THE DRAWINGS

Unless indicated otherwise, identical or functionally equivalent elements in the figures are identified by the same reference numbers.

FIG. 1 is a schematic illustration of a hammer drill 1 as an example of a chiseling portable hand tool. The hammer drill 1 has a tool holder 2, into which one end of a shank 3 of a tool 4, e.g., of the drill, can be inserted and locked. A primary drive of the hammer drill 1 forms an electric motor 5 which drives a percussion mechanism 6 and an output shaft 7. A battery pack 8 or a power supply supplies power to the electric motor 5. A user can guide the hammer drill 1 by means of a handle 9 and can start the hammer drill 1 by means of a system switch 10. In operation, the hammer drill 1 rotates the drill 4 continuously around a work axis 11 and can thereby strike the drill 4 in the percussion direction 12 along the work axis 11 into a substrate.

The percussion mechanism 6 is a pneumatic percussion mechanism 6. An exciter piston 13 and a striker 14 are guided in a guide tube 15 in the percussion mechanism 6 along the work axis 11. The exciter piston 13 is coupled by means of a cam 16 or a wobble finger to the electric motor 5 and driven in a periodic, linear motion. The exciter piston 13 is moved in a movement axis 17 specified by the guide tube 15 which preferably coincides with the work axis 11. A connecting rod 18 connects the cam 16 or the wobble finger with the exciter piston 13. A pneumatic spring formed by a pneumatic chamber 19 between the exciter piston 13 and the striker 14 couples a movement of the striker 14 to the movement of the exciter piston 13. The striker 14 can transmit a portion of its momentum to the drill 4 directly to a rear end of the drill 4 or indirectly by means of an essentially stationary rivet header 20. The percussion mechanism 6 and preferably the additional drive components are located inside a machine housing 21.

A piston wall 22 of the exciter piston 13 is essentially cylindrical and its diameter 23 is adapted to the guide tube 15 so that the piston wall 22 is in contact with the guide tube 15. The piston wall 22 slides along the interior surface of the guide tube 15, as a result of which the exciter piston 13 is guided parallel to the movement axis 17. A piston base 24 of the exciter piston 13 is oriented perpendicular to the movement axis 17. A diameter 23 of the piston base 24 or of the piston wall 22 is essentially equal to the inside diameter of the guide tube 15, so that the pneumatic chamber 19 is closed by the piston base 24.

The exciter piston 13 is connected to the cam 16 by means of the connecting rod 18. An axis of rotation 25 of the cam 16 is perpendicular to the movement axis 17 of the percussion mechanism 6. The cam 16 has, for example, a cam finger 26 which is rotationally engaged in an eye 27 on one end of the connecting rod 18. The connecting rod 18, on its other end, has a piston pin 28. The piston pin 28 is fastened inside the exciter piston 13 in a bearing 29, which allows the connecting rod 18 to pivot around a pivoting axis 30 that is parallel to the axis of rotation 25. The piston pin 28 is for that purpose oriented perpendicular to the movement axis 17. The piston pin 28 can be rigidly connected with the connecting rod 18, in particular, the piston pin 28 cannot rotate with respect to the connecting rod 18 around the pivoting axis 30. The connecting rod 18 and the piston pin 28 are preferably a cohesive monolithic physical unit which is manufactured from the same synthetic material, for example. The connecting rod 18 and the piston pin 28 can be manufactured in an injection molding process, for example.

“Monolithic” means that the connecting rod 18 and the piston pin 28 are connected with each other inseparably and without a joint zone. Alternatively, the connecting rod can have a second eye into which the piston pin is inserted. The piston pin is thereby rotational around the pivoting axis in relation to the connecting rod.

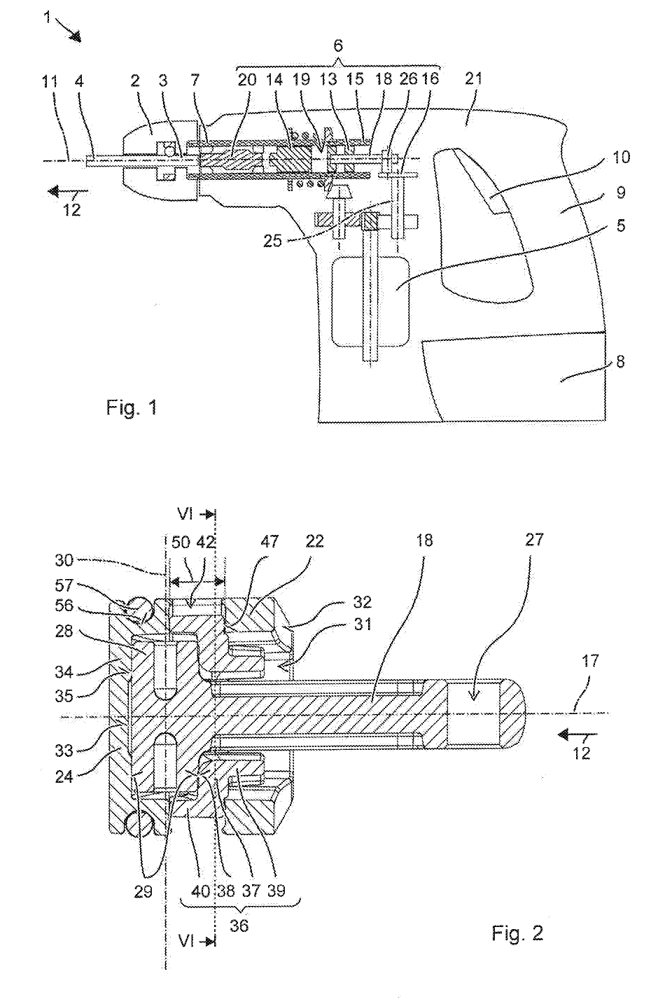

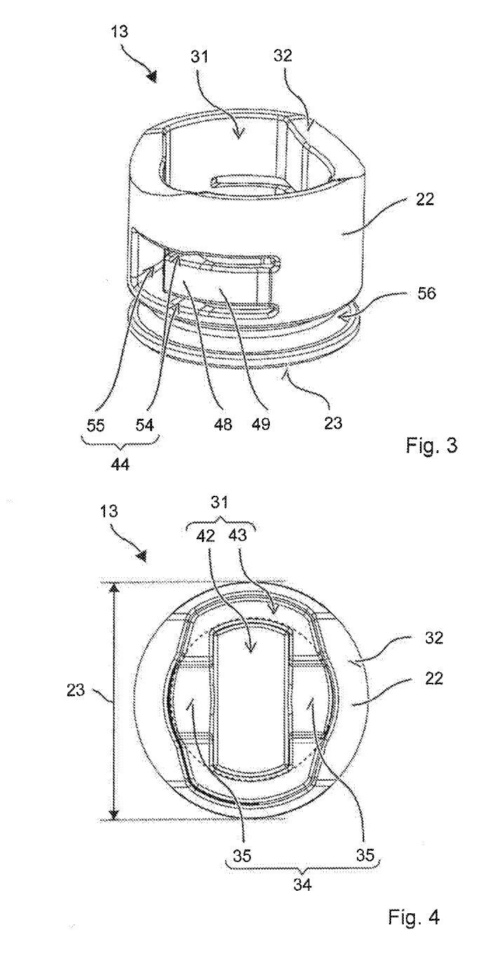

The bearing 29 for the piston pin 28 is located inside the exciter piston 13 (FIG. 2). The exciter piston 13 is essentially hollow (FIG. 3). The piston wall 22 and the piston base 24 enclose a cavity 31 which is open on the back side 32 facing away from the piston base 24. The piston pin 28 and the connecting rod 18 are inserted into the exciter piston 13 via the back side 32. The piston pin 28 is in contact with the inside 33 of the piston base 24. The inside 33 has a first bearing shell 34 (FIG. 4). The first bearing shell 34 preferably contains two semi-cylindrical bearing surfaces 35 which face opposite to the striking direction 12. The piston pin 28 is in form-fitting contact with the first bearing shell 34, i.e., against the semi-cylindrical bearing surfaces 35. The piston pin 28 is supported in the percussion direction 12 on the first bearing shell 34. The partly enclosing shape of the first bearing shell 34 in the directions of rotation around the movement axis 17 also prevents a rotational movement of the piston pin 28 in both directions of rotation around the movement axis 17.

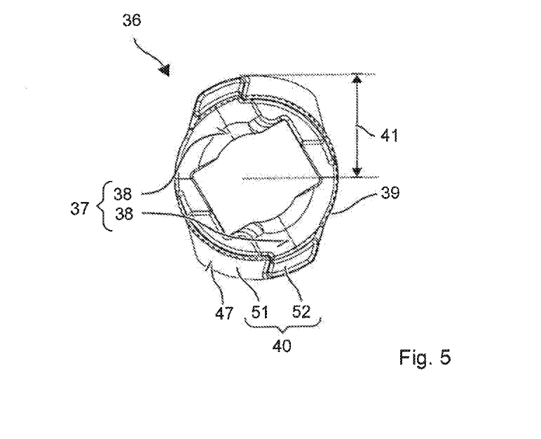

The bearing 29 is closed by a closure plate 36. The closure plate 36 contains a second bearing shell 37 which faces the first bearing shell 34 along the movement axis 17 (FIG. 5). The second bearing shell 37 is in contact with its bearing surfaces 38 in the percussion direction 12 against the cylindrical segments of the piston pin 28. The second bearing surfaces 38 can have a partly cylindrical shape which is in form-fitting contact against the piston pin 28. By way of example, the bearing surfaces 38 correspond to one-quarter of a cylinder. However, the bearing surfaces 38 are in contact against the piston pin 28 only in one direction of rotation around the movement axis 17. In one configuration, the bearing surfaces 38 can be flat. The bearing surfaces 38 of the closure plate 36 are exposed to low mechanical loads and can therefore be realized with a smaller contact surface with the piston pin 28.

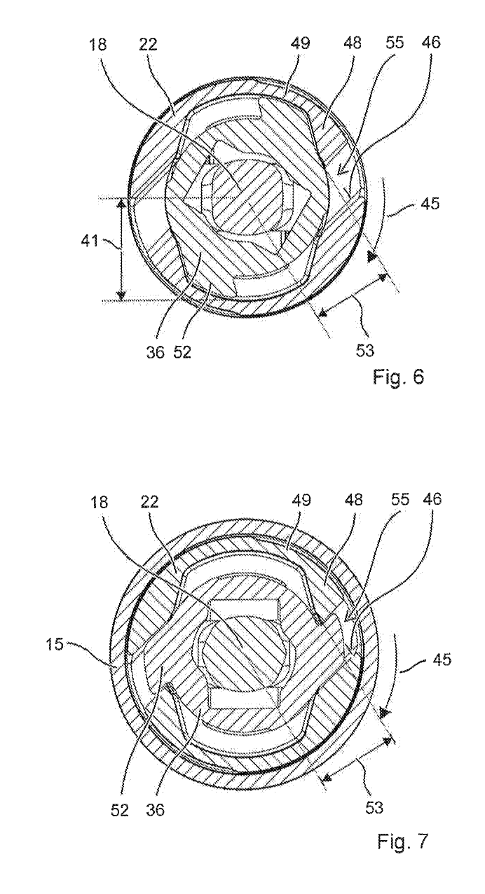

The closure plate 36 can be inserted along the movement axis 17 into the cavity 31 of the exciter piston 13. The profile of the cavity 31 along the movement axis 17 and the profile of the closure plate 36 along the movement axis 17 are preferably the same in terms of shape and size (FIG. 6). The profile is the projection along the movement axis 17 on the plane perpendicular to it. The closure plate 36 slides into the exciter piston 13 largely in a form-fitting manner along the movement axis 17 until it reaches the piston base 24, i.e., until it comes into contact against the first bearing shell 34.

Together with the piston wall 22 the closure plate 36 forms a rotational closure that fixes the closure plate 36 in position along the movement axis 17 in the exciter piston 13. The closure plate 36 has a cylindrical body 39 (indicated by the circle drawn in broken lines) and two fins 40 that project radially from the body and give the closure plate 36 a form characterized by non-rotational symmetry. Throughout the description, the radial direction relates to the movement axis 17 or the longitudinal axis of the exciter piston 13. The two fins 40 define the largest radial dimension 41 of the closure plate 36. The fins 40 shown by way of example are located diametrically with respect to the movement axis 17. The closure plate 36, instead of two fins, can also have another number of fins. The fins 40 can be oriented parallel to the piston base 24 or at a slight angle with respect to the piston base 24.

The cavity 31 has a cylindrical core 42 (indicated by the circle drawn in broken lines) and two radially projecting recesses 43 that have a uniform cross-section complementary to the fins 40 along the movement axis 17. The piston wall 22 encloses this cavity 31. The piston wall 22 has two grooves 44 that run parallel to the piston base 24 or optionally at the inclination of the fins 40 with respect to the piston base 24 (FIG. 7). The grooves 44 are open opposite to a direction of rotation 45 into the recesses 43. Throughout the description, the direction of rotation 45 relates to the movement axis 17 or the longitudinal axis of the exciter piston 13. The grooves 44 are offset in the direction of rotation 45 from the recesses 43. The grooves 44 can have a uniform depth or a variable depth along the direction of rotation 45. The depth, however, is determined so that a radial distance of the groove bottom from the movement axis 17 is greater than the radial dimension 41 of the closure plate 36, i.e., the distance of the fins 40 from the movement axis 17. The number and arrangement of the grooves 44 around the movement axis 17 corresponds to the location of the fins 40 around the movement axis 17.

The closure plate 36 is inserted into the exciter piston 13 along the movement axis 17 until the fins 40 are at the same height as the grooves 44. Then the closure plate 36 can be rotated around the movement axis 17, as a result of which the fins 40 slide into the grooves 44. The closure plate 36 can preferably be rotated by an angle of rotation between 45° and 90°, for example at least 60°, for example a maximum of 75°, around the movement axis 17. The maximum angle of rotation is limited by a stop 46 that is formed by the grooves 44 closed in the direction of rotation 45 or a stop of the closure plate 36 outside the grooves 44. The closure plate 36 is fixed in position by the rotational closure along the movement axis 17 in the exciter piston 13. The fins 40 are in contact inside the grooves 44 with a contact surface 47 opposite to the percussion direction 12. The tensile forces acting opposite to the percussion direction 12 on the exciter piston 13 are transmitted via the contact surface 47. The piston pin 28 enclosed between the two bearing shells 34, 37 fixes the connecting rod 18 in position in the exciter piston 13.

A detent 48 is provided in the groove 44. In its locking position, the detent 48 is engaged in the groove 44 and prevents a rotation of the fins 40 in the groove 44. During rotation of the closure plate 36, the detent 48 is deflected outward by the fins 40 in the radial direction into its releasing position. The fin 40 passes the detent 48 until the detent 48, after the fin 40, can return to the locking position. The pin 40 is captured in the groove 44 between the stop 46 and the detent 48. The detent 48, for example, is suspended on a spring element 49 which pushes the detent 48 into the locking position.

The groove 44, for example, has a uniform height 50, i.e., its dimension along the movement axis 17. The detent 48 has a lower height than the groove 44. The fin 40, for example, has a flat plate 51 and a bump 52. The flat plate 51 can slide in the groove 44 past the detent 48 in the direction of rotation 45 because they cannot overlap along the movement axis 17. The bump 52 comes up against the detent 48. In the locked position of the closure plate 36, the bump 52 is captured between the stop 46 and the detent 48.

The radial dimensions of the fin 40 and of the detent 48 are calculated so that the detent 48 must be deflected for the releasing position beyond the periphery of the piston wall 22. A radial distance 53 of the detent 48 from the movement axis is less than the radial dimension 41 of the closure plate 36 in the vicinity of the fin 40. The outside radius, i.e., half the diameter 23 of the piston wall 22 or the inside radius of the guide tube 15, is less than the sum of the radial distance of the fin 40 from the movement axis 17 and the radial dimension of the detent 48. When the exciter piston 13 is inserted into the guide tube 15, the guide tube 15 prevents a deflection of the detent 48 into the releasing position. The closure plate 36 is securely locked in position.

The detent 48 can be realized as part of the piston wall 22. The detent 48 is a tongue that projects into the groove 44. The piston wall 22 is thinner around the tongue so that the piston wall 22 gives when the fin 40 presses in the radial direction. On the illustrated detent 48, for example, the piston wall 22 is slotted adjacent to the detent 48. Longitudinal slots 54 run parallel to the groove 44 in the percussion direction 12, respectively above and below the detent 48. An opening 55 runs adjacent to the detent 48 parallel to the movement axis 17 and connects the two longitudinal slots 54. The segment of the piston wall 22 enclosed between the longitudinal slots 54, in the configuration as a flexure bearing, forms the spring element 49, which behaves elastically during the radial deflection of the detent 48 into the releasing position. The slots 54 extend all the way through the piston wall 22.

The exciter piston 13 has a peripheral channel 56 on the outside of the piston wall 22. A gasket 57 is inserted into the channel 56. The 56 channel overlaps with the piston pin 28 along the movement axis 17.

1.-9. (canceled)

10. A portable power tool, comprising:
a tool holder;
an electric motor;
a pneumatic percussion mechanism, wherein the pneumatic percussion mechanism includes an exciter piston guided along a movement axis in a guide tube and a striker coupled to the exciter piston via a pneumatic chamber and wherein a piston wall of the exciter piston contacts the guide tube;
a connecting rod, wherein the connecting rod is fastened on a first end to a piston pin in the exciter piston and is coupled on a second end with the electric motor;
a bearing, wherein the bearing supports the piston pin and wherein the bearing is formed by a piston head of the exciter piston and a closure plate disposed in the exciter piston and located opposite to the piston head;
a rotary closure, wherein the rotary closure is formed by a groove that runs in a direction of rotation around the movement axis in the piston wall of the exciter piston and by a radially protruding fin on the closure plate and wherein the fin is engaged in the groove; and
a detent, wherein the detent locks the fin counter to the direction of rotation, wherein the detent is pivotable in a radial direction between a locking position and a releasing position, and wherein the detent is deflectable beyond an external dimension of the piston wall in the radial direction in the releasing position.

11. The portable power tool according to claim 10, wherein in the locking position, the detent is engaged in the groove and lies completely inside the external dimension of the piston wall.

12. The portable power tool according to claim 10, wherein a distance of the detent from the movement axis is less than a radial dimension of the closure plate in a vicinity of the fin.

13. The portable power tool according to claim 10, wherein the detent is a monolithic segment of the piston wall.

14. The portable power tool according to claim 13, wherein a longitudinal slot parallel to the groove is formed in the piston wall adjacent to the detent.

15. The portable power tool according to claim 14, wherein the longitudinal slot penetrates the piston wall.

16. The portable power tool according to claim 10, wherein the detent has a spring element and wherein the detent is pushable by the spring element into the locking position.

17. The portable power tool according to claim 10, wherein the piston head has a first bearing shell, wherein the piston pin is in contact against the first bearing shell in the striking direction, wherein the closure plate has a second bearing shell, and wherein the piston pin is in contact with the second bearing shell opposite to the striking direction.

18. The portable power tool according to claim 10, wherein the fin has a flat plate and a bump that is raised with respect to the flat plate along the movement axis and wherein the flat plate is in contact with the groove opposite to the striking direction.
